(19) United States
(12) Patent Application Publication
(10) Pub. No.: US 2003/0081603 A1
(43) Pub. Date: May 1, 2003

(54) Pending data announcements

(76) Inventor: Johan Rune, Lidingo (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/983,906

(22) Filed: Oct. 26, 2001

(51) Int. Cl. H04L 12/28

(52) U.S. Cl. 370/390; 370/350

(57) ABSTRACT

In an ad-hoc network information about data pending in a master node is distributed to the slave nodes of the master node. The information about pending data can be distributed in a beacon message which is sent by a master node at the expiration of a beacon interval. Alternatively, the information can be distributed in every message transmitted by a master node. The information can be in the form of a list or a bit map. The information can be either an indication that data is pending in the master node, or the information can be more detailed. The more detailed information can include whether the data pending in the master node is in danger of being dropped by the master node, the size of the pending data or the urgency associated with the pending data. Yet an alternative is to use predefined time slots for each slave node of the master node to exchange information about pending data. The information sent from the master would concern data pending in the master for the particular slave. The information sent from the slave would concern data pending in the slave.

### BACKGROUND

The present invention relates to ad-hoc networks. More particularly, the present invention relates to scheduling in ad-hoc networks.

Conventional networking protocols are based on the characteristics and/or features of fixed networks. In fixed networks, the network configuration typically does not change. Although nodes can be added and removed in fixed networks, the route traveled by data packets between two nodes typically does not change. The disadvantage is that fixed networks cannot be easily reconfigured to account for increases in data traffic, also called system loading. Accordingly, when system loading increases for one node, the surrounding nodes are likely to experience increased delays in the transmission and reception of data.

In contrast to fixed networks, ad-hoc networks are dynamic. An adhoc network is formed when a number of nodes decide to join together to form a network. Since nodes in ad-hoc networks operate as both hosts and routers, ad-hoc networks do not require the infrastructure required by fixed networks. Accordingly, ad-hoc networking protocols are based upon the assumption that nodes may not always be located at the same physical location.

Bluetooth is an exemplary ad-hoc networking technology. Bluetooth is an open specification for wireless communication of both voice and data. It is based on a short-range, universal radio link, and it provides a mechanism to form small ad-hoc groupings of connected devices, without a fixed network infrastructure, including such devices as printers, PDAs, desktop computers, FAX machines, keyboards, joysticks, telephones or virtually any digital device. Bluetooth operates in the unlicenced 2.4 GHz Industrial-Scientific-Medical (ISM) band.

FIG. 1 illustrates a Bluetooth piconet. A piconet is a collection of digital devices, such as any of those mentioned above, connected using Bluetooth technology in an ad-hoc fashion. A piconet is initially formed with two connected devices, herein referred to as nodes. A piconet can include up to eight nodes. In each piconet, for example piconet 100, there exists one master node and one or more slave nodes. In FIG. 1 Bluetooth unit 101 is a master node and Bluetooth unit 102 is a slave node.

According to Bluetooth technology a slave node can only communicate directly with a master node. FIG. 2 illustrates a piconet with a master node 201 and a plurality of slave nodes 202-208 arranged in a star network topology. If slave node 202 wishes to communicate with slave node 206, slave node 202 would have to transmit the information it wished to communicate to master node 201. Master node 201 would then transmits the information to slave node 206. In addition to being classified as a master node and slave node, a node may be classified as an idle node. An idle node is a node which is not currently participating in a piconet.

A scatternet is formed by multiple independent and unsynchronized piconets. FIG. 3 illustrates an exemplary scatternet 300. In FIG. 3, piconet 1 includes a master node 303 and the slave nodes 301, 302 and 304; piconet 2 includes the master node 305 and the slave nodes 304, 306, 307 and 308; and piconet 3 includes the master node 309 and the slave nodes 308, 310 and 311. To implement a scatternet it is necessary to use nodes which are members of more than one piconet. Such nodes are herein referred to as forwarding nodes. If, for example, node 301 wishes to communicate with node 310, then nodes 304 and 308 might act as forwarding nodes by forwarding data between the two piconets and in particular between nodes 301 and 310. For example, node 301 transfers the information to the master node of piconet 1 node 303. Master node 303 transmits the information to forwarding node 304. Forwarding node 304 then forwards the information to master node 305, which in turn, transmits the information to forwarding node 308. Forwarding node 308 forwards the information to master node 309 which transmits the information to the destination node 310.

Bluetooth nodes communicate using a frequency hopping scheme which consists of 79 separate frequencies. The particular frequency hop sequence for a piconet is based upon the address of the master node, and the phase of the frequency hop sequence is based on the clock of the master node. Therefore, proximate piconets may operate based on different frequency hop sequences. Having only a single transceiver, a Bluetooth node can only be active in one piconet at a time. Thus, participation in multiple piconets is performed on a time division basis.

When temporarily “leaving” a piconet to be active in another piconet, a node may take measures to avoid being polled by the master node of the piconet from which it will be temporarily absent. Such measures may be to enter the HOLD mode, to use the SNIFF mode or to use a mechanism dedicated for this purpose. The HOLD mode is a single sleep mode period, the duration of which is agreed between the master node and the slave node before the slave node enters the HOLD mode. If, for instance, the HOLD mode is used by a node to facilitate participation in more than one piconet, the node enters a HOLD mode in one piconet while participating in another piconet. For example, after master node 303 forwards a packet to forwarding node 304, forwarding node 304 enters a HOLD mode with respect to piconet 1 and participates in piconet 2 so that forwarding node 304 can forward the packet to master node 305. The SNIFF mode can simply be described as a repetitive cycle of active mode behavior, i.e. the slave node listens for transmissions from the master node and responds when it is addressed) and a sleep mode (when the master node will not poll the slave node and the slave node will not listen for transmissions from the master node). The HOLD mode is not repetitive as the SNIFF mode.

The SNIFF and HOLD modes are mainly intended to be used to save power (since low power consumption is desirable since many Bluetooth devices are battery powered). The SNIFF and HOLD modes are two of the three power saving modes specified in Bluetooth; the third one is the PARK mode. All three of them reduce the fraction of the time that a Bluetooth slave node has to listen for transmissions from its master node. For more information regarding HOLD modes in Bluetooth networks, the interested reader should refer to U.S. Pat. No. 6,026,297 “Contemporaneous Connectivity To Multiple Piconets” to Jaap Haartsen, the entire disclosure of which is herein expressly incorporated by reference. In addition, both the SNIFF mode and the HOLD mode are described in the Bluetooth Core 1.0b and the Bluetooth Core 1.1 specifications from the Bluetooth Special Interest Group (SIG). It would also be possible for a node to switch to another piconet without changing modes or informing the master node in the first piconet in any manner. In such case the master node of the piconet from which the node is temporarily absent may waste capacity on polling the temporarily absent node. Nevertheless, as long as the node returns to the first piconet before the master node breaks the connection (due to lack of responses from the absent node), a node may participate in another piconet without informing the master node of the piconet from which the node is absent.

Each Bluetooth node has a globally unique 48 bit IEEE 802 address. This address, called the Bluetooth Device Address (BD_ADDR) is assigned when the Bluetooth node is manufactured and it has never changed. In addition, the master node of a piconet assigns a local active member address (AM_ADDR) to each active member of the piconet. The AM_ADDR, which is only three bits long, is dynamically assigned and deassigned and is unique only within a single piconet. The master node uses the AM_ADDR when polling a slave node in a piconet. However, when the slave node, triggered by a packet from the master node addressed with the slave node's AM_ADDR, transmits a packet to the master node, it includes its own AM_ADDR (not the master node's) in the packet header.

FIG. 4 illustrates the communications format used in Bluetooth networks. In Bluetooth networks, each radio channel is divided into a series of time slots. As illustrated in FIG. 4, these time slots alternate between time slots reserved for transmissions in the master to slave direction and time slots reserved for transmission in the slave to master direction. A master to slave time slot and a slave to master time slot together form a frame, which is illustrated in FIG. 4 by the darkened borders between slave to master time slots of one frame and master to slave time slots of the next frame.

As illustrated in FIG. 4, each time slot in a Bluetooth network can include a standard Bluetooth packet which consists of an access code field, a header field and a payload field. The access code field can include: a channel access code (CAC), which is derived from the BD_ADDR of the master node of the piconet and identifies the channel used in the piconet; a device access code (DAC) which is derived from the BD_ADDR of a particular Bluetooth unit and is used for special signaling procedures such as the PAGE procedure (used for establishing connections to other Bluetooth units); or an inquiry access code (IAC) which are used in the INQUIRY procedure (used to “discover” other Bluetooth units within radio range). When an inquiry access code is used, there is no header field and no payload. When a device access code is used, the packet may also lack both header and payload. In this case the packet consisting only of a DAC is referred to as an ID-packet. When the packet includes a payload it may be longer than one time slot. Multi-slot packets may occupy three or five consecutive time slots.

The header of the standard Bluetooth packet includes a three bit AM_ADDR field, used for addressing the Bluetooth packet, a four bit type field which indicates the type of baseband packet used and a one bit flow field to control the flow over an Asynchronous Connectionless Link (ACL). It will be recognized that an ACL link carries asynchronous data. The header also includes a one bit ARQN field which is used for automatic repeat requests to indicate acknowledgment or negative acknowledgment of the previous packet sent in the opposite direction, a one bit SEQN field for sequential numbering of packets which include a cyclic redundancy check (CRC), i.e., it is used to detect duplicated packets, and an eight bit header error check (HEC) field to check the header integrity.

The payload field of the standard Bluetooth packet can take on one of two different formats depending upon whether the packet is a single-slot packet or a multislot packet. A single slot packet includes a two bit logical channel field (L_CH), a one bit flow field which is used for flow control of the entire data flow, a five bit length field which defines the length of the payload in bytes (excluding the payload header itself and the CRC), the payload body containing the information to be transmitted and a sixteen bit CRC field. The multislot packet has a similar configuration to the single slot packet except that the length field is nine bits long and there is a four bit undefined field between the length field and the payload body field.

Even though all data is transmitted in packets, the packets can carry both synchronous data, on Synchronous Connection Oriented (SCO) links which is mainly intended for voice traffic, and asynchronous data, on ACL links. Depending on the type of packet that is used, an acknowledgment and retransmission scheme is used (not for SCO packets transferring synchronous data) to ensure reliable data transfer, as well as forward error correction (FEC) in the form of channel coding.

FIGS. 5A and 5B respectively illustrate the current and a proposed protocol stack for Bluetooth units. In FIG. 5A, the protocol stack, from the lowest to the highest protocol layer, includes the baseband layer, the data link layer including the link management protocol (LMP) and the logical link control and adaptation protocol (L2CAP), the network layer and generally the higher layer protocol or the application layer.

In order to support Internet Protocol (IP) in a Bluetooth scatternet, it has been proposed to regard an entire Bluetooth scatternet as an IP subnet. However, to do this requires an adaptation layer. Accordingly, FIG. 5B includes the proposed network adaptation layer between the data link layer and the network layer to allow Bluetooth units to communicate using IP.

As discussed above, a Bluetooth unit which is a member of more than one piconet can only be active in one piconet at a time. Accordingly, a member of more than one piconet will have to switch between piconets on a time division basis. To control the switching between piconets in the most efficient manner a scheduling algorithm, herein referred to as an inter-piconet scheduling algorithm, should be provided to control the switching between piconets. Inter-piconet scheduling algorithms can be based on well-known queuing algorithms such as Weighted Fair Queuing (WFQ), Class-Based Queuing (CBQ), Hierarchical Packet Fair Queuing (H-PFQ), Hierarchical Fair Service Curve (HFSC), or any other known queuing algorithm. These algorithms generally use the contents of different data buffers. The contents of the data buffers includes pending data transmissions on different connections, channels, links, etc. In the context of inter-piconet scheduling, the scheduling algorithms should ideally consider buffers in the node itself, which contains data to be transferred from the node, and buffers in neighboring nodes, which contain data to be transmitted to the node. However, there are currently no known mechanisms for obtaining information regarding data buffers of neighboring nodes in a Bluetooth network.

Accordingly, it would be desirable to provide methods and apparatus which allows a node which switches between networks to determine the buffer status of surrounding nodes. More specifically, it would be desirable to provide methods and apparatus which allows a Bluetooth node which performs inter-piconet switching to determine the status of buffers of neighboring nodes in all of the piconets in which the node participates so that the node can determine when it should return to a particular piconet to alleviate data in buffers of the node in the piconet which need to be transmitted to the node. The buffer status concerns both data that will be routed through the node and data that is destined for the node itself.

### SUMMARY

These and other problems, drawbacks and limitations of conventional techniques are overcome according to the present invention.

The data buffers in the node itself are easily available, but the status of the buffers in neighboring nodes, herein referred to as “remote buffers”, may be difficult to determine. One method for informing the node of the contents of the neighboring nodes' buffers is for the neighboring nodes to continuously provide information about the status of their relevant buffer(s). Another method involves the node making its own assumptions about the status of the remote buffers based on the traffic flow from the neighboring nodes. However, while a node which switches between different piconets is absent from a piconet, herein referred to as a “passive piconet”, the node does not receive any data from that piconet. Hence, it receives neither explicit buffer information nor a traffic flow to base its own assumptions as to the status of buffers in a node in the passive piconet. Furthermore, if a slave node would want to quickly visit a passive piconet in order to be able to receive data to get some indication (explicit or implicit) of the status of the remote buffer(s), it can generally not expect to be polled exactly at the time when it makes its quick visit to the passive piconet.

In accordance with one embodiment of the present invention, a beacon interval is defined for a piconet. Accordingly, all nodes which are members of the piconet attempt to return to the piconet at the expiration of the beacon interval to receive information regarding pending data that the master node has queued for its slave nodes. A node which returns to each piconet in which it is a member at the expiration of the various beacon intervals thereby obtains information regarding the buffer status of the master node in each piconet that the node participates.

In accordance with one aspect of the present invention, information regarding which nodes have queued data in the master node is provided in the beacon message by a bit map. Alternatively, the information can be provided in a list of nodes for which the master node has queued data. Further, the beacon message can include information about the size of the pending data, an indication of whether the pending data is in danger of being dropped by the master node, an indication of urgency associated with the queued data and/or information regarding the next planned piconet switch of the master node.

In accordance with another embodiment of the present invention, information regarding queued data is transmitted in every packet by the master node. Accordingly, a node can return to a piconet at any time and determine the buffer status by reading any packet transmitted by the master node. In accordance with one aspect of the present invention, a packet pending/no packet pending indication is included as a bit map in the baseband header of a Bluetooth packet. Further, a polling pause indicator can be sent to the node whose address is included in the baseband packet, i.e., the node for which the packet contains payload data, to inform the slave node that the master node will not poll the slave node for a predetermined number of frames.

In accordance with another aspect of the present invention, a packet pending/no packet pending indication can be placed as a bit map in the payload header of a packet. In accordance with yet another aspect of the present invention, the baseband packet can include a dynamic extension to the payload header. In accordance with this aspect, a one bit header extension indicator in the payload header is set to indicate that the payload header is being extended to include information regarding queued data in the master node. Alternatively, the reserved value ‘00’ of the L_CH field in the payload header can be used to indicate the presence of the header extension. In addition, a polling pause indicator can be included as part of the payload header extension.

In accordance with yet another embodiment of the present invention, information regarding queued data in the master node and the slave node can be exchanged in predefined time slots. Each slave node in a piconet would be assigned such dedicated reoccurring predefined time slots. By exchanging the information during predefined time slots, a slave node need only return to a piconet during the predefined time slots to obtain information regarding the buffer status. Further, since these time slots are particular to each slave node, the predefined time slots can be selected based upon the activity of the slave node.

In accordance with one embodiment of the present invention information regarding pending data in an ad-hoc network which includes at least a master node and a slave node is provided. A message is broadcast from the master node indicating whether data is pending in the master node for any of the slave nodes of the master node. The slave node returns to the master node's network if the slave node is not currently active in the master node's network, wherein the slave node returns to the master node's network and the master node broadcasts the message once every predefined interval. The message is received by the slave node and the slave node controls the time in which the slave node participates in all of the networks in which the slave node is a member as a function of the message.

In accordance with another embodiment of the present invention a message is sent from the master node to the slave node, wherein the message includes, in addition to any data intended for the slave node, an indication of whether data is pending in the master node for any of the slave nodes of the master node. The message is received by another slave node which controls the time in which the another slave node participates in all of the networks in which the another slave node is a member as a function of the message.

In accordance with yet another embodiment of the present invention a message is sent from the master node to the slave node indicating whether data is pending in the master node for the slave node. The slave node returns to the master node's network if the slave node is not currently active in the master node's network, wherein the slave node returns to the master node's network and the master node sends the message once every predefined interval, wherein the predefined interval is unique for each slave of the master node's network. The slave node receives the message and controls the time in which the slave node participates in all of the networks in which the slave node is a member as a function of the message.

### BRIEF DESCRIPTION OF THE DRAWINGS

The objects and advantages of the invention will be understood by reading the following detailed description in conjunction with the drawings in which:

FIG. 1 illustrates an exemplary piconet;

FIG. 2 illustrates an exemplary star-topology network;

FIG. 3 illustrates an exemplary scatternet formed by a plurality of piconets;

FIG. 4 illustrates a conventional Bluetooth packet;

FIGS. 5A and 5B respectively illustrate the protocol layers of the current Bluetooth protocol and of an Internet Protocol compatible Bluetooth protocol;

FIG. 6 illustrates signaling between a master and slave nodes in a piconet in accordance with one embodiment of the present invention;

FIG. 7 illustrates a baseband packet for a beacon message in accordance with one embodiment of the present invention;

FIGS. 8A and 8B respectively illustrate methods for a master node and slave nodes in accordance with one embodiment of the present invention;

FIG. 9 illustrates an exemplary method for avoiding systematic collisions between beacon messages and synchronous connection oriented (SCO) packets in accordance with one embodiment of the present invention;

FIGS. 10A-10D illustrate baseband packets in accordance with another embodiment of the present invention;

FIG. 11 illustrates a method for providing pending packet indications in accordance with another embodiment of the present invention; and

FIG. 12 illustrates method for providing pending data indications in accordance with yet another embodiment of the present invention.

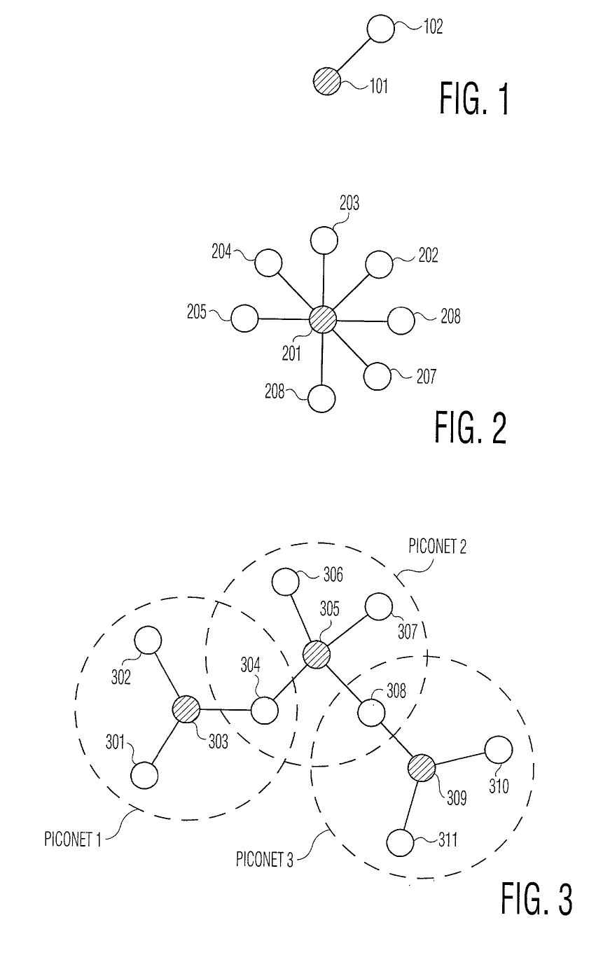

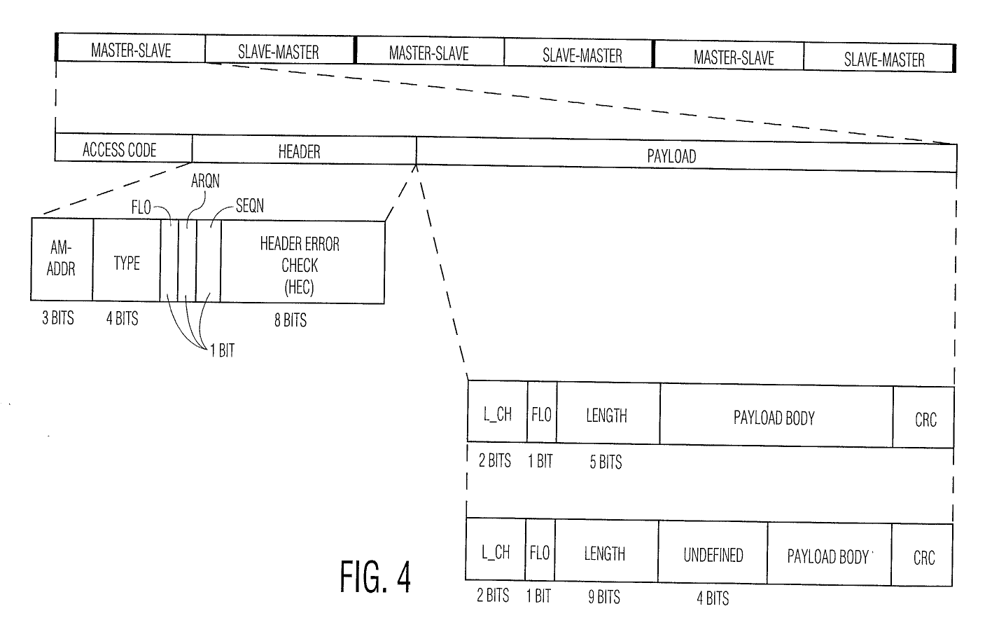

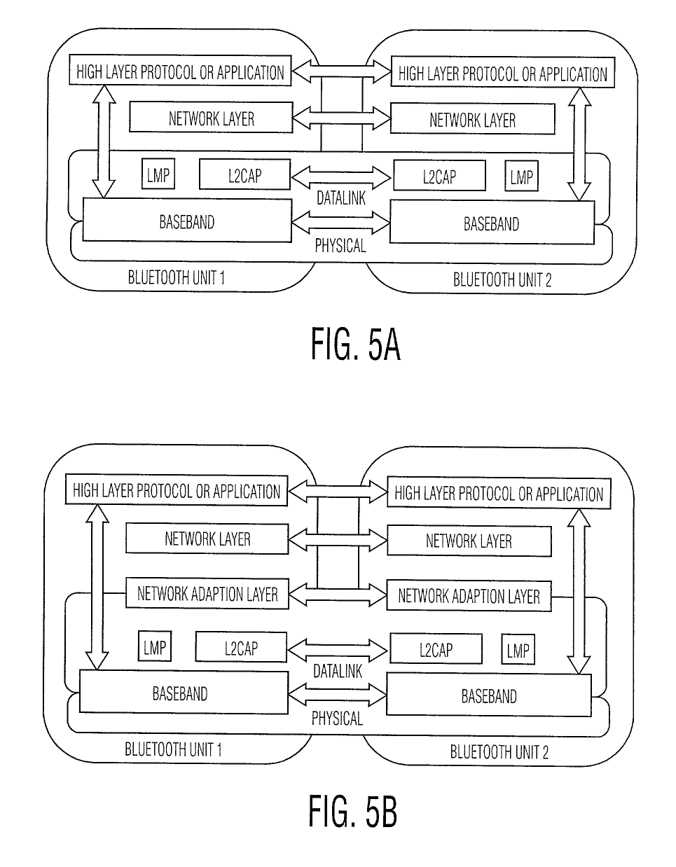

### DETAILED DESCRIPTION

The present invention is directed to ad-hoc networks. More particularly, the present invention is directed to obtaining information regarding pending data transmissions from neighbor nodes in an ad-hoc network.

In the following description, for purposes of explanation and not limitation, specific details are set forth, such as particular sequences of inter and intra network signaling, types of messages, etc. in order to provide a thorough understanding of the present invention. However, it will be apparent to one skilled in the art that the present invention may be practiced in other embodiments that depart from these specific details. In other instances, detailed descriptions of well-known methods, devices, and network elements are omitted so as not to obscure the description of the present invention. In the following the phrases pending data and queued data are used interchangeably to refer to data that is stored in a node's buffer which is awaiting transmission to another node.

As discussed above, it is desirable to have a mechanism which allows a first node to find out whether a second node has packets waiting to be sent. It is especially desirable for a node which participates in more than one piconet, herein referred to as a multi-homed node, to determine whether master nodes in the piconets in which the multi-homed node participates have data to be sent to the multi-homed node. It will be recognized that when a master node leaves its own piconet to participate in another piconet, the communication in the master node's own piconet is halted. Accordingly, most multi-homed nodes will be slave nodes.

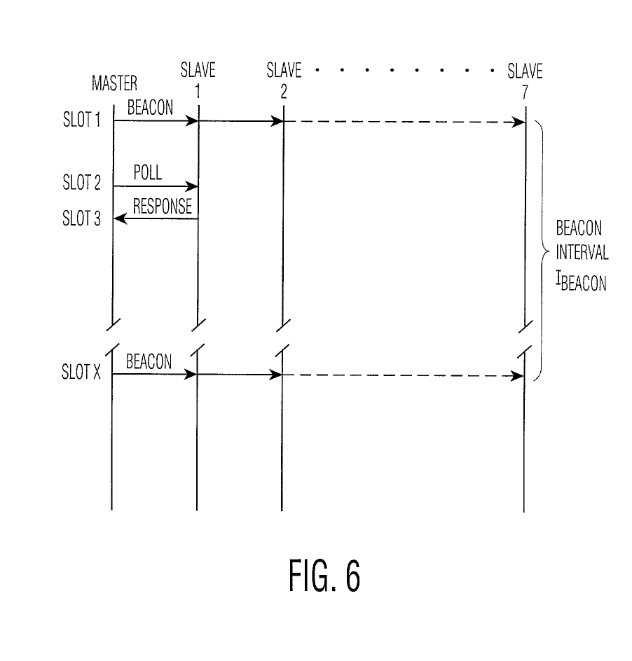

FIG. 6 illustrates the signaling within a piconet in accordance with one embodiment of the present invention. In FIG. 6 the vertical axis represents time. Accordingly, the break in the time axis of FIG. 6 is intended to illustrate that the beacon interval can be longer than the few time slots illustrated. Further, the dashed lines in the horizontal axis illustrates that a piconet can have between one and seven active slave nodes.

In accordance with the embodiment of the present invention illustrated in FIG. 6, a master node of each piconet regularly broadcasts a beacon message containing information regarding pending data which the master node has queued for all of its slave nodes. It will be recognized that this type of “beacon message” can also be called a pending data announcement message. These beacon messages are transmitted in predefined time slots. Accordingly, as illustrated in FIG. 6, in slot 1, the master node broadcasts a beacon message to all of its slave nodes. The master node and the slave nodes then continue to communicate in a conventional manner, as illustrated by the poll and response messages between the master node and slave node 1 in FIG. 6. Further, although not illustrated in FIG. 6, a node may leave the piconet between beacon messages to participate in other piconets. When the predetermined beacon interval I_{beacon} expires, the master node again broadcasts a beacon message to all of the slave nodes of its piconet. It will be recognized that the piconet illustrated in FIG. 6 with seven slave nodes is merely exemplary and the piconet may have less then seven slave nodes.

In accordance with exemplary embodiments of the present invention, the predefined beacon interval, which can be expressed as a number of frames, is selected such that multi-homed nodes return to the piconet often enough so that the master node rarely has to drop packets intended for the multi-homed nodes, but not so often that the throughput of the piconet is significantly reduced due to the broadcasting of the beacon messages. The start of the beacon time slot can be defined by modulo (CLK₂₇₋₂ₘₐₛₜₑᵣ, I_{beacon})=0, wherein CLK₂₇₋₂ₘₐₛₜₑᵣ represents bits 2-27 of the master node's clock expressed in frames in a bit numbering system which begins with the least significant bit numbered 0. Modulo (CLK₂₇₋₂ₘₐₛₜₑᵣ, I_{beacon}) indicates the remainder after integer division between CLK₂₇₋₂ₘₐₛₜₑᵣ and I_{beacon}. It will be recognized that the time period for the start of the beacon time slot is in fact valid for 1.25 ms, while the two lowest bits of the clock completes a cycle, but the result of the modulo operation defines the start of this 1.25 ms time period.

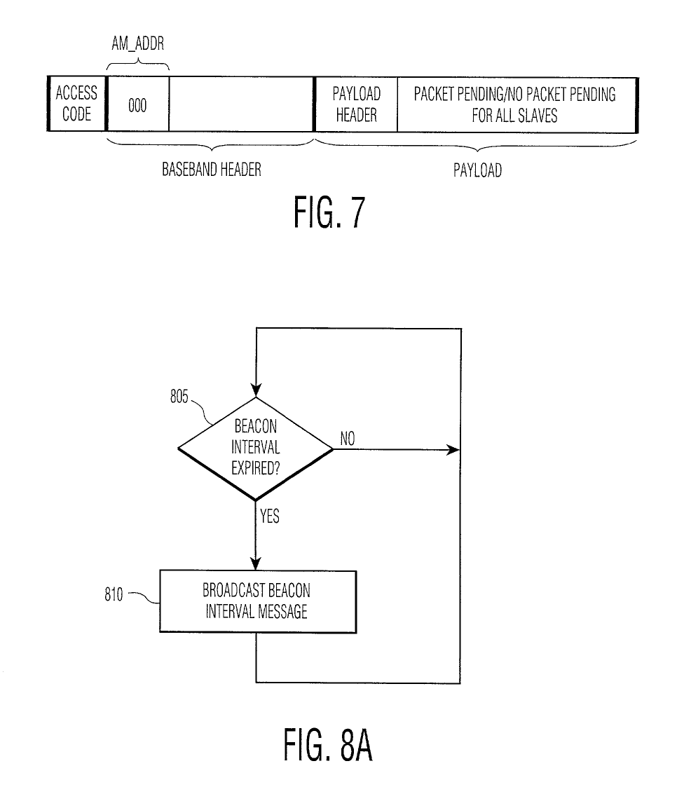

FIG. 7 illustrates a packet which can be used for the beacon messages in accordance with exemplary embodiments of the present invention. An all zero address in the AM_ADDR field of the Bluetooth baseband packet indicates that the packet is a broadcast packet. Accordingly, as illustrated in FIG. 7, the AM_ADDR field of the baseband header is set to three zeros. The data to be included in the beacon message to indicate the status of the master node's queue for a particular node is placed in the payload section of the baseband packet, indicated in FIG. 7 by the packet pending/no packet pending field, which is herein referred to as a data indication. In accordance with one embodiment of the present invention the data indication is provided in bit map form where seven bits are used to indicate the status in the master node for the slave nodes with AM_ADDR one through seven respectively. The bit map will contain a bit value of one in a particular bit position if the master node has data to be transmitted to the slave node whose AM_ADDR corresponds to the particular bit position, while a bit value of zero indicates that there is no data to be transmitted to the slave node from the master node. As an alternative to using a bit map as a data indication, a list of AM_ADDRs of the slave nodes for which the master node has data to send can be included in the payload of the baseband packet. In accordance with this alternative, the AM_ADDRs of slave nodes for which the master node has no data to send are not included in the list.

In addition to including the data indications discussed above, the beacon message can also include other information which may be useful for multi-homed nodes' inter-piconet scheduling algorithms. For example, the beacon message can include information about the size of the pending data, e.g., the number of packets and/or the number of bytes. Additionally, the beacon message can include an indication of whether the pending data, either all or part of it, is in danger of being dropped by the master node. Further, the beacon messages can include indications of the urgency of the data queued in the master node and/or the protocol associated with the data, e.g., L2CAP or LMP, or a L2CAP channel identifier. The beacon message can also include information regarding the next planned piconet switch of the master node, if one is planned to occur.

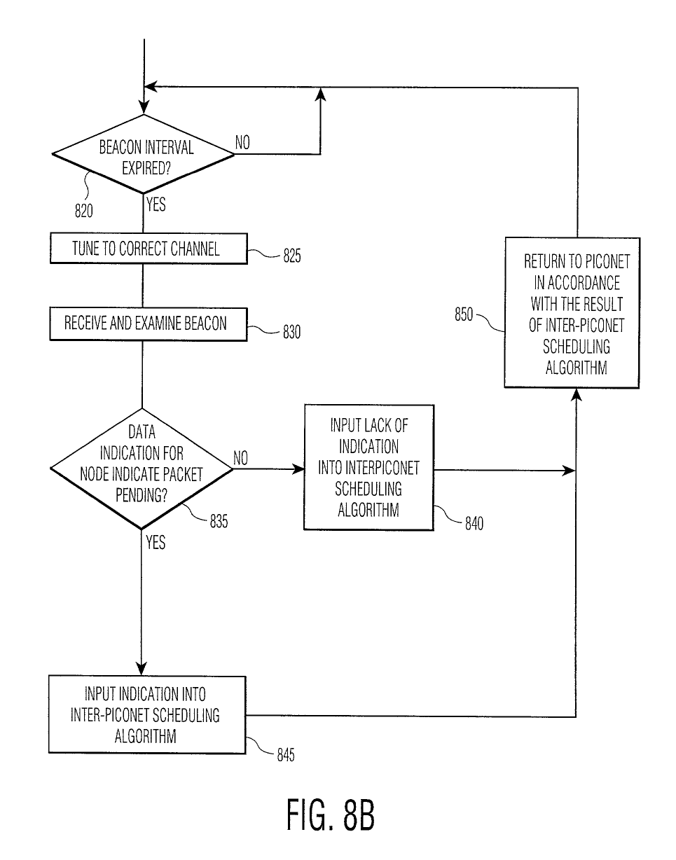

FIG. 8A illustrates a method for implementing beacon messages in a master node in accordance with exemplary embodiments of the present invention. As illustrated in FIG. 8A, the processing of the master node for implementing beacon messages is quite simple. The master node continuously determines whether it is time to send a beacon message (step 805). If the master node determines that it is not time to send the beacon message (“No” path out of decision step 805) then the master node continues its normal procedures until it is time to send the beacon message. If the master node determines that it is time to send a beacon message (“Yes” path out of decision step 805) then the master node broadcasts the beacon message (step 810) and returns to its normal procedures until the next beacon interval expires.

FIG. 8B illustrates a method for implementing beacon messages in a slave node in accordance with exemplary embodiments of the present invention. Initially, the slave node determines whether the beacon interval has expired for one of the piconets in which the slave node participates (step 820). If the beacon interval has not expired (“No” path out of decision step 820) the slave node then continues its normal processing until the beacon interval expires. If, however, the beacon interval for one of the piconets in which the slave node participates in expires (“Yes” path out of decision step 820) then the slave node tunes to the channel associated with the particular piconet (step 825). The slave node will then receive and examine the beacon message (step 830). It will be recognized that if a slave node is currently participating in the piconet for which the beacon interval has expired, the slave node will already be tuned to the correct channel, and hence, the slave node will skip step 825.

After examining the beacon message, the slave node determines whether there is a data indication for the slave node which indicates that a packet for that node is pending in the master node (step 835). If there is no data indication for the node (“No” path out of decision step 835), the slave node will insert this information into its inter-piconet scheduling algorithm (step 840) and return to the piconet in accordance with the result of the inter-piconet scheduling algorithm (step 850). For example, the results of the inter-piconet scheduling algorithm can include participating in another piconet, or if the slave node has data to send in the piconet, the slave node will remain in the piconet until it is polled by the master node to allow the slave node to transmit the data.

If there is a data indication for the slave node in the beacon message (“Yes” path out of decision step 835), then the slave node inputs the indication into the inter-piconet scheduling algorithm (step 845) and then returns to the piconet in accordance with the result of the inter-piconet scheduling algorithm (step 850). For example, if the data indication for the slave node is set to “packet pending”, the inter-piconet scheduling algorithm may indicate that the slave node should return to the piconet as soon as possible, return to the piconet in which the slave node was participating prior to returning to listen for the beacon message, or visit a third piconet depending upon the traffic demands of the different piconets.

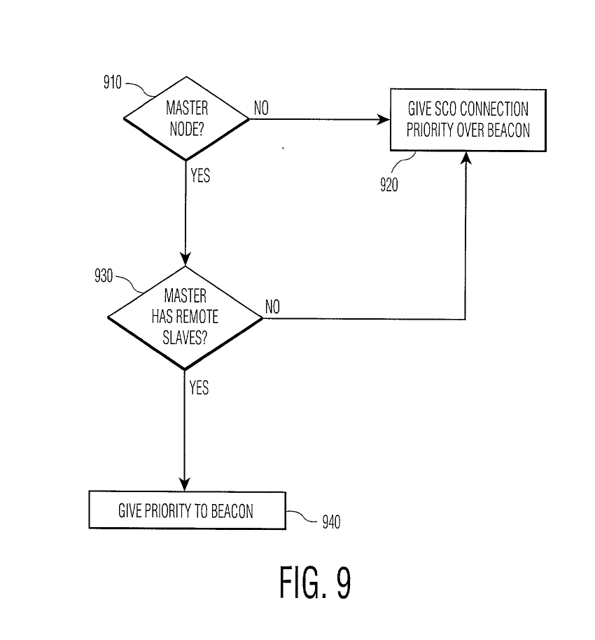

As previously discussed, Bluetooth piconets support both asynchronous connectionless (ACL) links and synchronous connection oriented (SCO) links. SCO links are used primarily for time delay sensitive traffic such as voice traffic. To avoid introducing delay on SCO links, the SCO connections use regularly occurring reserved time slots, with the time slot interval selected to yield the bit rate required for the particular SCO links. Accordingly, it may occur that the beacon message time slot and an SCO time slot for a particular node occurs at the same time. FIG. 9 illustrates an exemplary method for addressing the situation in which sporadic, but not systematic, collisions occur between the SCO time slots and the beacon message time slots. If the node is not a master node (“No” path out of decision step 910), then the remote slave node gives priority to the SCO connection of another piconet over the beacon message of the piconet to which the remote slave node is to return to at the expiration of the beacon interval in order to maintain high quality traffic processing for the SCO connection (step 920). If a beacon message time slot in a slave node's current piconet collides with an SCO time slot for the slave node in the same piconet, there is no conflict from the slave node's point of view since the slave node has to listen in the master node's transmission time slot anyway. Further, depending on the priority rules used by the master node, the slave node will receive either an SCO packet or a broadcast beacon message from the master node.

If the node is a master node (“Yes” path out of decision step 910), then the master node determines whether it supports remote slave nodes in its piconet (step 930). If the master node does not support remote slave nodes (“No” path out of decision step 930), then the master node will give priority to the SCO connection (step 920) since none of its slave nodes have to return to its piconet for the beacon message. If, however, the master node does support remote slave nodes (“Yes” path out of decision step 930) the master node gives priority to the beacon message (step 940) so that remote nodes which are returning to listen to the beacon message do not waste their time returning when no beacon message is to be transmitted.

Since the master node may not always know whether there are remote slave nodes a simpler method may be desired. This simpler method includes the master node always giving priority to SCO connections in its own piconet, when it is present in its own piconet. But when it is absent, i.e. when it is temporarily visiting another piconet as a slave node, it will give priority to sending the beacon message in its own piconet over a colliding SCO time slot in the piconet it is visiting. It will be recognized that any type of priority rule can be implemented with the present invention to handle the collision between SCO time slots and beacon message time slots and that the present invention is not limited to the particular priority rules described above.

In addition to sporadic collisions between beacon time slots and SCO time slots, systematic collisions may occur between these time slots. For example, if the beacon interval is an integer multiple of an existing SCO time slot interval and the beacon time slot and the SCO time slot collide once, then every beacon time slot will collide with an SCO time slot. To avoid this correlated periodicity between beacon time slots and SCO time slots, the number of frames in a beacon interval should be selected to be a prime number. For example, the prime number 97 may be chosen as the beacon message interval. The beacon message time slots would then be completely predictable based solely on the clock of the master node, i.e., the beacon time slot is identified by the relation modulo (CLK₂₇₋₂ₘₐₛₜₑᵣ, 97)=0. It will be recognized that using the value 97 as the beacon message interval results in, once every clock cycle (which is approximately 23 hours), a beacon interval of less than 97 frames, since a complete clock cycle is not an integer multiple of 97 frames.

An alternative to using a prime number of the beacon message interval to avoid systematic collisions between beacon message time slots and SCO time slots is to allow a limited amount of flexibility in sending the beacon message. For example, the master node could be allowed to send the beacon message in either the predefined beacon time slot or in the subsequent master transmission time slots, i.e., two time slots after the predefined beacon time slot since the time slot immediately following the beacon message time slot will be a time slot reserved for the slave to master direction of transmission. This flexibility would avoid many of the SCO collisions and would have only a limited impact on the predictability of the transmission time of the beacon message from a remote slave node's point of view.

In accordance with another embodiment of the present invention, instead of periodically transmitting beacon messages to provide data indications, the data indications can be provided in every packet transmitted from the master node. By providing data indications in every packet transmitted from a master node, a multi-homed node need not interrupt its current participation in another piconet to return to the original piconet to listen for a beacon message. Instead, the multi-homed node can return to an original piconet at any time to receive the pending data indication.

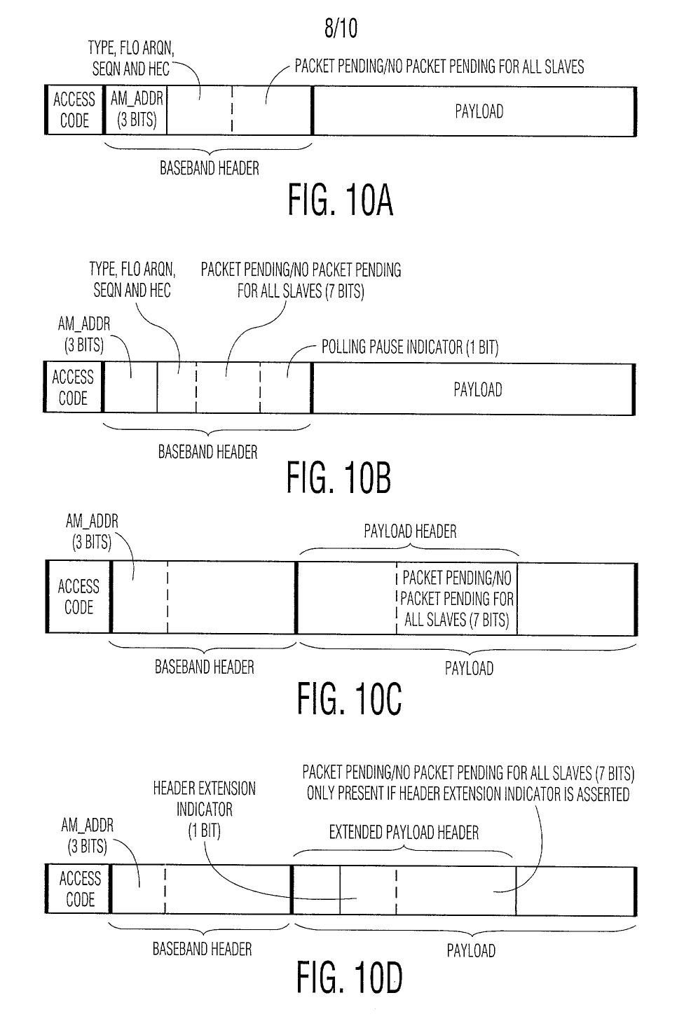

FIG. 10A illustrates one exemplary master-slave direction packet for providing pending data indications to slave nodes. As illustrated in FIG. 10A, the packet pending/no packet pending indication is provided as an extension to the baseband header of the Bluetooth packet. Accordingly, the baseband header is now 25 bits in length. The packet pending/no packet pending indication in accordance with this embodiment of the present invention is in the form of a bit map. Since any particular piconet can have at most seven active slave nodes, each bit of the seven bits in the packet pending/no packet pending indication corresponds to the AM_ADDR assigned to one of the slave nodes. Accordingly, the AM_ADDR field in the packet illustrated in FIG. 10A will contain the address of the particular slave node for which the payload data is intended. However, since all active slave nodes in a piconet will be able to hear all of the messages transmitted by the master node, each active slave node can examine the baseband header to determine whether the master node has pending packets for it. It should be noted that only the packets transmitted in the direction from the master node to the slave node will be modified as illustrated in FIG. 10A.

FIG. 10B illustrates another exemplary packet which is transmitted in the master-slave direction for providing pending data indications to slave nodes. Similar to the packet illustrated in FIG. 10A, the packet in FIG. 10B includes a bit map in the baseband header to provide packet pending/no packet pending indications to all the slave nodes. However, in the embodiment illustrated in FIG. 10B, a one bit polling pause indicator is appended to the seven bit packet pending/no packet pending indicator. Accordingly, the baseband header is now 26 bits in length. The polling pause indicator is used to inform the slave node receiving the packet, i.e., the node whose address is in the AM_ADDR field of the baseband header, that the master node will not poll the slave node for a predetermined number of frames. For example, if the polling pause indicator bit is asserted then the node whose address is in the AM ADDR field would know that the master node will not poll the slave node. Accordingly, if the slave node is a multi-homed node, the slave node can use the time period of the subsequent predetermined number of frames to visit another piconet to check for pending packets or perform other processing. In accordance with one embodiment of the present invention the predetermined number of frames for the polling pause is ten frames, although other predetermined number of frames can be implemented as long as all nodes know the predetermined number of frames which is associated with the polling pause indicator.

Depending upon the intra-piconet scheduling scheme implemented, the polling pause indicator may or may not be useful to a master node. An intra-piconet scheduling algorithm like Batched Fair Exhaustive Polling (B-FEP), which is described in U.S. patent application Ser. No. 09/455,172 to Per Johansson et al. filed Dec. 6, 1999, the contents of which are herein expressly incorporated by reference, can make use of a polling pause indicator. B-FEP schedules nodes in batches, which allows a master node to know when the currently polled slave node appears again in the same batch, if the node appears again at all. Hence, a master node using B-FEP as an intra-piconet scheduling algorithm would easily be able to use the polling pause indicator. However, an intra-piconet scheduling scheme with less predictability (but maybe more flexibility) may not be able to use the polling pause indicator. In that case, the polling pause indicator would always be cleared, i.e., indicating that no information is available.

FIG. 10C illustrates yet another exemplary packet which is transmitted in the master-slave direction for providing pending data indications to slave nodes. Similar to the packets illustrated in FIGS. 10A and 10B, a bit map is used to provide the packet pending/no packet pending indications. However, in accordance with this embodiment the indication is placed in the payload header of the baseband packet. In accordance with this embodiment, the packet pending/no packet pending indications are a fixed extension to the payload header that is always present in baseband packets transmitted in the master to slave direction, when the baseband packet includes a payload header. Although not illustrated in FIG. 10C, the fixed extension to the payload header can include a polling pause indicator which operates in a manner similar to that described above in connection with FIG. 10B.

FIG. 10D illustrates a further exemplary packet which is transmitted in the master-slave direction for providing pending data indications to slave nodes. The baseband packet illustrated in FIG. 10D includes a dynamic extension to the payload header. Accordingly, if the one bit header extension indicator in the payload header is set then the seven bit packet pending/no packet pending indication follows the header extension indicator. Conversely, if the one bit header extension indicator is not set then the data portion of the payload begins immediately following the normal payload header. The dashed line between the header extension indicator and the packet pending/no packet pending indicator illustrates that if the header extension indicator is set then the payload header is extended into the portion of the payload normally used for the payload data. Although not illustrated in FIG. 10D, this embodiment can also include a polling pause indicator subsequent to the packet pending/no packet pending indicator. The polling pause indicator would only be present, even if it is not set, if the header extension indicator is set.

If the dynamic header extension is used only for data indications and optionally for a polling pause indicator, the header extension indicator will only be present in baseband packets transmitted in the master-to-slave direction. If, however, the dynamic extension is used for other purposes, the header extension indicator may have to be present in the payload header regardless of the direction of the packet. A dynamic extension to the payload header would be a less severe modification of the current Bluetooth standard specification than an extension of the baseband packet header as described in connection with FIGS. 10A and 10B. However, placing the packet pending/no packet pending indications in the payload header has other disadvantages. Since the payload header is one step higher than the baseband packet header in the protocol hierarchy, it requires more processing from non-addressed slave nodes to extract the packet pending/no packet pending indications from the payload header. Furthermore, not all baseband packets contain a payload header, but all of them contain a baseband packet header.

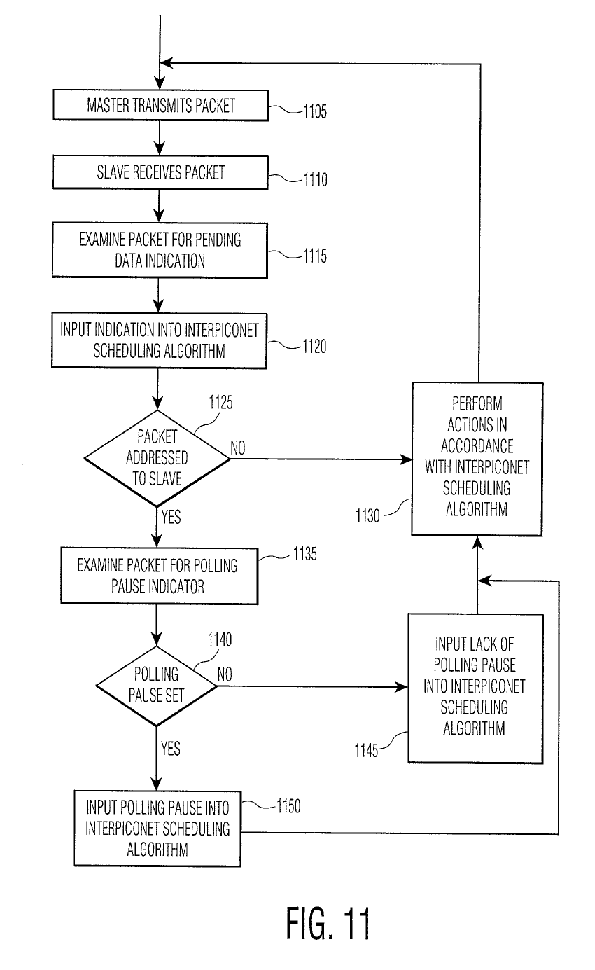

FIG. 11 illustrates an exemplary method for providing pending data indications to slave nodes in accordance with the another embodiment of the present invention. Initially, the master node transmits a packet (step 1105). The packet can be any of the packets illustrated in FIGS. 10A-10D. Next, a slave node receives the packet (step 1110) and examines the packet for the pending packet indication for the particular slave node (step 1115). The particular portion of the packet that the slave node examines depends upon which one of the packets illustrated in FIGS. 10A-10D is implemented. The packet which is implemented is predetermined and known to all compatible nodes.

The information for the particular slave node in the pending packet indication is then inserted into the inter-piconet scheduling algorithm for the particular slave node (step 1120). The slave node then determines, based upon the AM_ADDR of the baseband packet, whether the packet is addressed to the slave node (step 1125). If the packet is not addressed to the slave node (“No” path out of decision step 1125) then the slave node continues normal processing and participates in various piconets in accordance with the result of the updated inter-piconet scheduling algorithm (step 1130). If, however, the packet is addressed to the slave node (“Yes” path out of decision step 1125) then the slave node examines the packet for a polling pause indicator (step 1135) and determines whether the polling pause indicator is set (step 1140). If the polling pause indicator is not set (“No” path out of decision step 1140), then this information is input into the inter-piconet scheduling algorithm for the node (step 1145) and the node performs actions in accordance with the inter-piconet scheduling algorithm (step 1130). If, however, the polling pause indicator is set (“Yes” path out of decision step 1150), then this information is input into the inter-piconet scheduling algorithm for the node (step 1150) and the node performs actions in accordance with the inter-piconet scheduling algorithm (step 1130). The return path illustrated in FIG. 11 from step 1130 to step 1105 illustrates that this method is performed for each packet transmitted from a master node.

One drawback associated with including pending data information in every data packet transmitted from the master node is that with this method backwards compatibility may be difficult to achieve. Via the LMP_features_req/LMP_features_res PDU exchange it would be easy to make sure that packets with the information about pending packets would be sent only to slave nodes that expect this information in an extended header. However, the purpose of this information is that not only the addressed receiver of the packet should receive the information. All slave nodes, present and remote, should be able to benefit from the pending data information in any packet transmitted by the master node. Hence, if the new header format is used selectively, depending on how advanced the addressed receiver is, the “eavesdropping” slave nodes would have to know whether the addressed slave node supports the new header format or not. Otherwise they would not be able to correctly interpret the received information. Therefore, in order to be able to implement this method in a piconet where not all of the slave nodes support the new header format, all the slave nodes that support the new header format have to be informed of which slave nodes that do not support it. To inform the slave nodes which support the new header format of the slave nodes which do not support the new header format, all of the present slave nodes supporting the new header format can be informed of this property of each new slave node that joins the piconet. European Patent Office Publication No. 1107516 “Methods and Arrangements in a Telecommunication System” to Telefonaktiebolaget L M Ericsson published on Dec. 6, 1999, the entire contents of which are herein expressly incorporated by reference, describes methods which can distribute this type of status information in a piconet. But the remote slave nodes would not be informed of the status since they, by definition are not present in the piconet to receive such information. Thus a remote slave node and a present slave node that receives a packet addressed to another slave node, and the status of this other slave node's compatibility with this scheme is unknown, should treat the header as being of the old format and thus not try to analyze any information about pending data. A first prerequisite for using the new header format in a piconet is of course that the master node supports it. This method to overcome the backwards compatibility problem will work at the expense of increased overhead and complexity.

An alternative method for dealing with the backwards compatibility problem would be to mandate that the new header format be used only if all the slave nodes in the piconet support the new format. The master node would then have to inform all the slave nodes before it starts using the new format. Furthermore, if a non-supporting slave node subsequently joins the piconet, the master node would have to inform the other slave nodes that the master node will revert to the old packet format. It will be recognized that the master node may however not be able to reach all the remote slave nodes with this information before it has to start using the old format when communicating with the new slave node, i.e., before the connection with the new slave node times out. This may not be too disruptive, though, even if a remote slave node would incorrectly interpret a transmission to the new slave node. The worst consequence would be that the remote slave node believes that there is no data pending when in fact there is, or the other way around. Yet an alternative would be that the master node, after announcing that the new header format will be used, rejects all attempts to join the piconet by nodes that do not support the new header format. Although these methods for addressing the backwards incompatibility problem would also work, they tend to result in an undesirable increase in complexity and restrictions.

A way to eliminate the backwards compatibility problem is to use the currently reserved ‘00’ value of the L_CH field in the payload header to indicate the presence of an extended payload header including the packet pending/no packet pending indications. Since the L_CH field always will be in the same position in the payload header, irrespective of its value, an “eavesdropping” slave node would not have to know which header format that is used when it interprets the L_CH field. Further, when interpreting the L_CH field, this will give an unambiguous indication of the presence or absence of the header extension, since the value L_CH=‘00’ will not be used unless the header extension is present. Hence, if L_CH=‘00’ in a received packet, an “eavesdropping” slave node would go on to interpret the packet pending/no packet pending indication corresponding to its own AM_ADDR in the payload header extension. If the L_CH field has any other value, the “eavesdropping” slave node would not process the packet further.

Another similar way to eliminate the backwards compatibility problem is to include the packet pending/no packet pending indications in the signaling data field of a packet containing both user data and signaling data using the in-band signaling mechanism described in U.S. Patent Application No. ______ (Attorney Docket No. 040071-819) “In-Band Signaling” to Johan Rune et al. filed Oct. 9, 2001, the entire contents of which are herein expressly incorporated by reference. This mechanism also uses the value L_CH=‘00’ as an indication in order to avoid the backwards compatibility problems. In this in-band signaling mechanism the value L_CH=‘00’ indicates that the baseband packet includes a signaling data field in addition to the regular user data field in the payload section of the baseband packet. The value L_CH=‘00’ also indicates the presence of an extension to the payload header. In accordance with this mechanism, the length of the signaling data field is indicated in the payload header extension.

As compared to the beacon method, the method in which data indications are sent in every packet in the master-to-slave direction allows a remote slave node to get information about pending packets from any master node transmission and therefore the remote slave node can return at any time to receive this information. Further, the information is then available in a more timely manner than in the “beacon message” method and it is easier for a remote slave node to fit the data indication monitoring into its schedule, e.g. with the aid of a polling pause indicator. A present slave node gets more or less continuous information about pending packets by monitoring the master node's transmissions, which it would monitor anyway. The polling pause indicator is an attractive feature. It may give multi-homed slave nodes frequent opportunities for brief visits to passive piconets to check for pending packets.

As compared to the beacon message method, the method in which pending data indications are sent in every packet in the master to slave direction results in more bandwidth being consumed for the data indications. Further, as described above, the modification of the baseband header or the payload header may result in backwards compatibility problems.

Accordingly, the present invention allows a remote slave node to easily obtain information about possible pending data in a piconet from which it is currently absent. Further, the slave node does not have to be polled to receive the information. Additionally, the information made available can greatly facilitate piconet switch decisions and in general the information is more or less essential for many conceivable inter-piconet scheduling algorithms to perform well.

The beacon message method can be made backwards compatible. Only a single new message, preferably an LMP PDU, has to be specified. Further, in the beacon message method predictable beacon timeslots facilitates the monitoring of beacon messages for a remote slave node. In addition, the beacon message method, by using a beacon interval of a prime number of frames, avoids systematic collisions with SCO timeslots. In the beacon message method, the beacon messages could be used to carry only simple indications of pending data or more elaborate information about the pending data. In addition the beacon message could be used to carry other information, e.g. inter-piconet scheduling related information. The extended header method is very efficient at providing the pending data information to remote slave nodes in a timely manner, i.e., quickly after the data became pending and almost at the instant when it is desired by a remote slave node. The extended header method provides the slave nodes present in a piconet almost continuous information about the status of pending data in the master node. The polling pause indicator in the “extended header” method provides a slave node opportunities to briefly visit other piconets to check for pending data, without the risk of missing polls in the piconet where it is currently active.

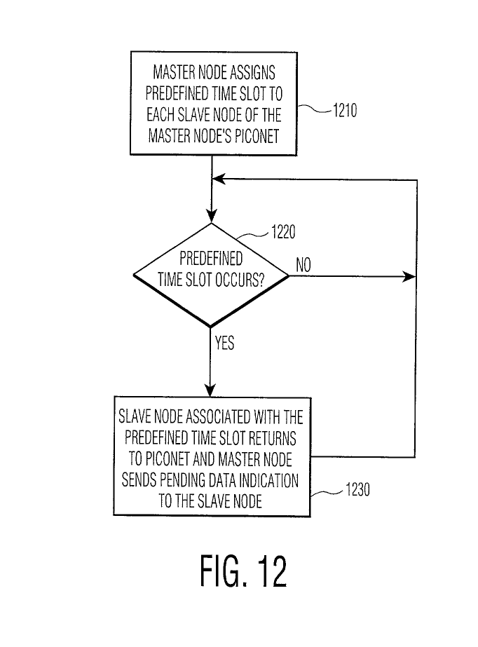

As an alternative to the beacon message embodiment and the embodiment in which pending data indications are sent in every packet in the master to slave direction, a predefined time slot between a master node and each of the slave nodes can be used to distribute information regarding pending data. FIG. 12 illustrates an exemplary method in accordance with this embodiment of the present invention. Initially, the master node assigns a predefined time slot to each slave of the master node's piconet (step 1210). In accordance with one aspect of the present invention, the predefined time slots are selected based upon information already known by the master node and the slave node. For example, the predefined time slot can be defined based upon the clock of the master node, the BD_ADDR of the master node, the BD_ADDR of the slave node and/or the AM_ADDR of the slave node.

So that the predefined time slot is unique for each slave node in a piconet it is preferable to base the predefined time slot upon at least some information related to the slave node. For example, the predefined time slot can be based upon the AM_ADDR of the slave node and the clock of the master node. In accordance with this aspect, the master clock cycle can be divided into sub-cycles of, for example, 128 frames each, and each slave node is assigned a predefined time slot in each subcycle. The position of a particular slave node's predefined time slot in the subcycle can be defined by the AM_ADDR of the slave node, for example, by adding an offset to the beginning of the subcycle. The size of the offset can be dependent upon the AM_ADDR, for example, predefined time slot=(AM_ADDR-1)*Offs frames, wherein Offs is preferably 18 if the subcycle length is 128 frames.

To increase the robustness of this solution, redundancy can be introduced into the predefined time slot embodiment. For example, instead of using a single frame, i.e., one time slot in each direction, for the information exchange, two, three or more frames could be predefined to allow a master node and a slave node to exchange pending data information. Additionally, to avoid systematic collisions with SCO timeslots, the predefined time slot can be pseudo-randomly changed for each slave node offset in the subcycle. Alternatively, the subcycle length can be set to a length equal to a prime number of frames in a similar manner to that discussed above in connection with the beacon message embodiment.

As an alternative to using a predefined algorithm to determine each slave node's predefined time slot, each slave node can negotiate with the master node to agree upon a cycle or algorithm to be used to derive the predefined time slots. This introduces more flexibility than using the same predefined algorithm for all slave nodes using information that is always available to both master and slave nodes. However, allowing master and slave nodes negotiate the predefined time slots introduces complexity into the system.

Returning now to FIG. 12, it is determine whether the predefined time slot occurs (step 1220). If the predefined time slot does not occur (“No” path out of decision step 1220), then the master node and the slave nodes of the piconet continue their normal processing until the predefined time slot occurs. If the predefined time slot does occur (“Yes” path out of decision step 1220), then the particular slave node associated with the predefined time slot returns to the piconet and the master node sends a pending data indication to the slave node (step 1230). In accordance with this embodiment, the slave node will know that it should be polled by the master node during the predefined time slot. However, the master node may choose not to poll the slave node, for example, if the predefined time slot collides with an SCO time slot. Similarly, the slave node need not actually return to the piconet associated with the master node during the predefined time slot if, for example, the predefined time slot collides with an SCO time slot which the slave node supports in another piconet. Since time slots in Bluetooth are paired, i.e., one time slot in the master to slave direction and the following time slot in the slave to master direction, the slave node can respond to the master node in the subsequent time slot to provide information regarding data pending in the slave node.

Using the predefined time slots, the pending data information can be transferred as the sole information in the time slot or it can be included with other signaling data. Further, the pending data information can be included with user data, in a so called piggy-backing manner, to make more efficient use of the time slots. Since the master node uses a predefined time slot for each slave node, and the information transferred during the predefined time slot is only for a particular slave node, a master node can support pending data information distribution with all slave nodes which support it even if not all of its slave nodes support it. Hence, there are no backwards compatibility problems with this method.

Although the present invention has been described in connection with Bluetooth networks and protocols, it will be recognized that the present invention is applicable to all types of networks and protocols. For example, the present invention can be used in any type of network in which a node participates on a time division basis between more than one network.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method for providing information regarding pending data in an ad-hoc network, the ad-hoc network including at least a master node and a slave node, the method comprising the steps of:
broadcasting a message, from the master node, indicating whether data is pending in the master node for any of the slave nodes of the master node;
returning to the master node's network by the slave node, if the slave node is not currently active in the master node's network, wherein the slave node returns to the master node's network and the master node broadcasts the message once every predefined interval;
receiving the message by the slave node; and
controlling, by the slave node, the time in which the slave node participates in all of the networks in which the slave node is a member as a function of the message.

2. The method of claim 1, further comprising the steps of:
returning to the master node's network by another slave node, if the another slave node is not currently active in the master node's network, wherein the another slave node returns to the master node's network once every predefined interval;
receiving the message by the another slave node; and
controlling, by the another slave node, the time in which the another slave node participates in all of the networks in which the another slave node is a member as a function of the message.

3. The method of claim 1, wherein the message includes a bit map which indicates which slave nodes have data pending in the master node.

4. The method of claim 1, wherein the message includes a list of slave nodes for which the master node has data pending.

5. The method of claim 1, wherein the message also includes information about the size of the pending data.

6. The method of claim 5, wherein the message also includes information about whether the pending data is going to be dropped by the master node.

7. The method of claim 5, wherein the message also includes an indication of urgency associated with the pending data.

8. The method of claim 1, wherein the message also includes information regarding a next network switch of the master node.

9. The method of claim 1, wherein the ad-hoc network operates in accordance with Bluetooth protocol.

10. The method of claim 1, wherein the slave node operates on a time-division basis between the master node's network and any other network in which the slave node participates.

11. The method of claim 1, wherein the predefined interval is a prime number of time slots.

12. The method of claim 1, further comprising the steps of:
broadcasting another message, from the master node, indicating data pending in the master node for all slave nodes of the master node;
returning to the master node's network by the slave node, if the slave node is not currently active in the master node's network, wherein the slave node returns to the master node's network at the predefined interval and the master node broadcasts the another message two time slots after the predefined interval;
receiving the another message by the slave node; and
controlling, by the slave node, the time in which the slave node participates in all of the networks in which the slave node is a member as a function of the another message.

13. A method for providing information regarding pending data in an ad-hoc network, the ad-hoc network including at least a master node and a slave node, the method comprising the steps of:
sending a message, from the master node to the slave node, wherein the message includes, in addition to any data intended for the slave node, an indication of whether data is pending in the master node for any of the slave nodes of the master node;
receiving the message by another slave node;
controlling, by the another slave node, the time in which the another slave node participates in all of the networks in which the another slave node is a member as a function of the message.

14. The method of claim 13, wherein the indication of data pending in the master node is included in a header of the message.

15. The method of claim 14, wherein the header is a baseband header.

16. The method of claim 14, wherein the header is a payload header of the message.

17. The method of claim 13, wherein the message includes a polling pause indicator which indicates to the slave node that the master node will not poll the slave node for a predetermined time period.

18. The method of claim 13, wherein the indication of data pending in the master node is conveyed in a bit map.

19. The method of claim 13, wherein the indication of data pending is included in an extension to a header of the message, the presence of the extension to the header indicated by a bit in the header.

20. The method of claim 13, further comprising the step of:
notifying, all slave nodes of the master node that support the indication of pending data, of which slave nodes of the master node support the indication of pending data.

21. The method of claim 13, wherein the master node only indicates the data pending if all slave nodes support the pending data indication.

22. A method for providing information regarding pending data in an ad-hoc network, the ad-hoc network including at least a master node and a slave node, the method comprising the steps of:
sending a message from the master node to the slave node, wherein the message indicates that the master node will not poll the slave node for a predetermined time period; and
controlling, by the slave node, the time in which the slave node participates in all of the networks in which the slave node is a member as a function of the predetermined time period.

23. The method of claim 22, wherein the message further includes an indication of whether data is pending in the master node for the slave node.

24. The method of claim 23, wherein the indication of whether data is pending in the master node for the slave node is conveyed in a bit map.

25. The method of claim 23, wherein the indication of whether data is pending in the master node for the slave node is conveyed in a list.

26. An ad-hoc network comprising:
a first subnetwork, the first subnetwork including a first master node;
a second subnetwork, the second subnetwork including a second master node;
a slave node, the slave node participates in the first and second subnetworks on a time-division basis;
wherein the first master node broadcasts a message indicating whether data is pending in the first master node for any of the slave nodes of the first master node, and
wherein the slave node returns to the first subnetwork, if the slave node is not currently active in the first subnetwork, and the first master node broadcasts the message once every predefined interval.

27. The network of claim 26, wherein the second master node broadcasts a message indicating data pending in the second master node for all slave nodes of the second master node, and
wherein the slave node returns to the second subnetwork, if the slave node is not currently active in the second subnetwork, and the second master node broadcasts the message once every another predefined interval.

28. The network of claim 27, wherein the slave node controls the time in which the slave node participates in the first and second subnetworks as a function of the messages.

29. The network of claim 26, wherein the message includes a bit map which indicates which slave nodes have data pending in the master node.

30. The network of claim 26, wherein the message includes a list of slave nodes for which the master node has data pending.

31. The network of claim 26, wherein the message also includes information about the size of the pending data.

32. The network of claim 31, wherein the message also includes information about whether the pending data is going to be dropped by the master node.

33. The network of claim 31, wherein the message also includes an indication of urgency associated with the pending data.

34. The network of claim 26, wherein the ad-hoc network operates in accordance with Bluetooth protocol.

35. The network of claim 26, wherein the slave node operates on a time-division basis between the master node's network and any other network in which the slave node participates.

36. The network of claim 26, wherein the master node broadcasts another message indicating data pending in the master node for all slave nodes of the master node,
wherein the slave node returns to the master node's network if the slave node is not currently active in the master node's network, wherein the slave node returns to the master node's network at the predefined interval and the master node broadcasts the another message two time slots after the predefined interval,
wherein the slave node receives the another message and controls the time in which the slave node participates in all of the networks in which the slave node is a member as a function of the another message.

37. An ad-hoc network comprising:
a first subnetwork, the first subnetwork including a first master node;
a second subnetwork, the second subnetwork including a second master node;
a slave node, the slave node participates in the first and second subnetworks on a time-division basis;
wherein in every message sent by the first master node the message includes, in addition to any data intended for the slave node to which the message is addressed, an indication of whether data is pending in the first master node for any of the slave nodes of the first master node.

38. The network of claim 37, wherein the slave node controls the time in which the slave node participates in all of the networks in which the slave node is a member as a function of the message.

39. The network of claim 37, wherein the indication of data pending in the master node is included in a header of the message.

40. The network of claim 39, wherein the header is a baseband header.

41. The network of claim 39, wherein the header is a payload header of the message.

42. The network of claim 37, wherein the message includes a polling pause indicator which indicates to the slave node that the master node will not poll the slave node for a predetermined time period.

43. The network of claim 37, wherein the indication of data pending in the master node is conveyed in a bit map.

44. The network of claim 37, wherein the indication of data pending is included in an extension to a header of the message, the presence of the extension to the header indicated by a bit in the header.

45. The network of claim 37, wherein the master node informs all of the slave nodes that support the indication of pending data, of which slave nodes of the master node support the indication of pending data.

46. The network of claim 37, wherein the master node only indicates the data pending if all slave nodes support the pending data indication.

47. The network of claim 37, wherein the indication of data pending is included in an extension to a header of the message, wherein the presence of the extension to the header is indicated by an L_CH field being set to 00.

48. A method for providing information regarding pending data in an ad-hoc network, the ad-hoc network including at least a master node and a slave node, the method comprising the steps of:
sending a message, from the master node to the slave node, indicating whether data is pending in the master node for the slave node;
returning to the master node's network by the slave node, if the slave node is not currently active in the master node's network, wherein the slave node returns to the master node's network and the master node sends the message once every predefined interval, wherein the predefined interval is unique for each slave of the master node's network;
receiving the message by the slave node; and
controlling, by the slave node, the time in which the slave node participates in all of the networks in which the slave node is a member as a function of the message.

49. The method of claim 48, further comprising the steps of:
determining the unique predefined interval for each slave node in the master node's network; and
informing the each slave node of the respective unique predefined interval.

50. The method of claim 49, wherein the unique predefined interval is selected based upon a member address of the master node's network for each slave node.

51. The method of claim 50, wherein the unique predefined interval is selected also based upon a clock of the master node.

52. The method of claim 48, further comprising the step of:
negotiating, by the master node, the unique predefined interval with each slave node.

53. The method of claim 48, further comprising the step of:
responding, by the slave node, to the message from the master node, wherein the response contains information about data pending in the slave node for the master node.
